(19) United States
(12) Patent Application Publication
(10) Pub. No.: US 2021/0276113 A1
(43) Pub. Date: Sep. 9, 2021

(54) Integrated mechanism for welding filler feed-forward maintaining device

(71) Applicants: Dung-Di Yu, Taoyuan City (TW); Sheng-Long Jeng, Taoyuan (TW); Chien-Chou Lee, Taoyuan (TW)

(72) Inventors: Dung-Di Yu, Taoyuan City (TW); Sheng-Long Jeng, Taoyuan (TW); Chien-Chou Lee, Taoyuan (TW)

(21) Appl. No.: 16/810,858

(22) Filed: Mar. 6, 2020

(51) Int. Cl. B23K 3/06; B23K 37/02

(52) U.S. Cl. CPC B23K 3/063; B23K 37/02

(57) ABSTRACT

A welding filler feed-forward maintaining device is provided with a sliding block on a sliding rail mechanism, wherein the sliding jail mechanism is an end shaft of a working space, which is suitable tor use of the end arm of a robot arm, and a main bracket is vertically erected to pivot on the sliding block via a pivoting seat, and the main bracket extends to a welding head at one end, and an end of a solder conduit for soldering is bent toward the soldering tip, and a discharge port for leading the solder is furnished, and a pivoting drive assembly coupled to the pivoting seat is further disposed on the sliding block and is configured to drive the pivoting seat to pivot the main bracket in order to keep the discharge port in front of the weld head along the varying welding direction.

### BACKGROUND OF THE INVENTION

### 1. Field of the Invention

The invention provides a feed-forward maintaining device for a welding filler, in particular to a feed-forward maintaining device capable of maintaining the relative position of a solder discharge port and the welding head according to different processing directions to maintain an optimum solder filling point.

### 2. Description of Related Art

With various matured and developed mechanical automation technologies, in the automation process of various welding, such as argon welding devices, the provision of automatic feeding equipment is an indispensable means to improve processing efficiency, and due to the processing environment and production requirements, the simple automated welding equipment developed by the industry for specific processes is mostly designed for specific machines to fulfil the demand of mass production.

The conventional automatic welding equipment generally has a welding device and a separate solder wire filling mechanism, and the welding device is provided with a welding torch capable of generating high temperature at one end, and the solder wire filling mechanism is provided with a solder wire feeding nozzle for discharging the solder wire. The solder wire feeding nozzle and the welding torch are disposed on one side of a moving platform and fixed at corresponding positions.

In the operation, the mobile platform is capable of performing sliding to facilitate linear welding of the linear joint of the drum or the square barrel by the welding device and the solder wire feeding mechanism. The mobile platform can also be a rotary disc driven by a motor for 360 degrees, and is positioned with a pneumatic cylinder, a jig, a linear slide, etc., for welding a circular workpiece, so that it is difficult to realize a diversified path as a whole to fulfil welding requirements.

In the above structure, since the solder wire feeding nozzle and the welding torch are in a fixed relative position during the moving and welding process, the wire feeding nozzle is always located on a side of the welding torch in the fixing direction. When welding the weld bead of the 2D combined path, such as horizontal straight line, circular arc, oblique line, and vertical straight line, as shown in FIG. 1, it can be found that the upper horizontal straight bead has a good appearance, where the nozzle is set in front of the welding torch at the feed-forward position, but the remaining part of the weld bead is unevenly shaped due to the change of the orientation of the filler, and some of the weld bead is scratched, thus resulting in an undesirable application.

In view of the above-mentioned shortcomings of the conventional welding device and the automatic feeding mechanism, the present invention aims to mitigate these setbacks by providing an integrated mechanism for filler feed-forward maintaining welding machine.

### SUMMARY OF THE INVENTION

The main object of the present invention is to provide a welding filler forward feeding maintenance device, which is provided with a sliding block on a sliding rail mechanism, a main bracket vertically pivoted on the sliding block via a pivoting seat, extending at one end to a soldering tip, a solder conduit for guiding solder is disposed on the side of the main bracket, and the solder conduit forms a discharge port for guiding the solder, a pivoting drive assembly coupled to the pivoting seat is further disposed on the sliding block, a pivoting drive assembly is configured to drive the pivoting seat to pivot the main bracket, and the sliding rail mechanism can drive the sliding block moving along a preset working path, cooperating with the pivoting drive assembly to drive the main bracket to pivot, keeping the discharge port in front of the welding head along the welding direction, thereby achieving optimal welding quality and weld bead morphology.

Another object of the present invention is to provide a welding filler feed forward maintaining device, wherein the discharge port is always located in front of the welding head along the welding direction, and when the solder is led out from the discharge port, the welding head is also oriented at the discharge port so that the solder can smoothly extend beneath the welding head and is in contact with the workpiece for effective heating by the welding head. Therefore, when the processing path is set, the moving path of the welding head can be set to extend along the welding bead without any other compensation parameters required, thereby effectively reducing production time and cost, promoting the competitiveness of products.

In order to achieve the abovementioned objects and effects, the technical means adopted by the present invention include: a sliding block is disposed on a sliding rail mechanism which is the end shaft of a mechanical arm in the working space, a main bracket is vertically erected on the sliding block via a pivoting seat, and one end of the main bracket extends to a welding head, a feeding mechanism has a solder conduit capable of transporting solder, and the end of the solder conduit is provided with a discharge port for leading the solder; a pivoting drive assembly is disposed on the sliding block and coupled to the pivoting seat, and the pivoting drive assembly is configured to drive the pivoting seat to pivot the main bracket such that the discharge port is always located in front of the welding head in the welding direction.

According to the above structure, the feeding mechanism has a feed drive assembly that is coupled to the solder conduit, and the feed drive assembly is capable of pushing the solder into the solder conduit and transporting toward the discharge port.

According to the above structure, a solder holder is disposed at one end of the main bracket away from the soldering tip, and a solder reel that supports the solder roll is pivotally disposed on the solder holder.

Other objects, advantages and novel features of the invention will become more apparent from the following detailed description when taken in conjunction with the accompanying drawings.

### BRIEF DESCRIPTION OF THE DRAWINGS

FIG. 1 is a schematic view of the profile of a weld bead welded by a conventional welding device and a filler feed mechanism.

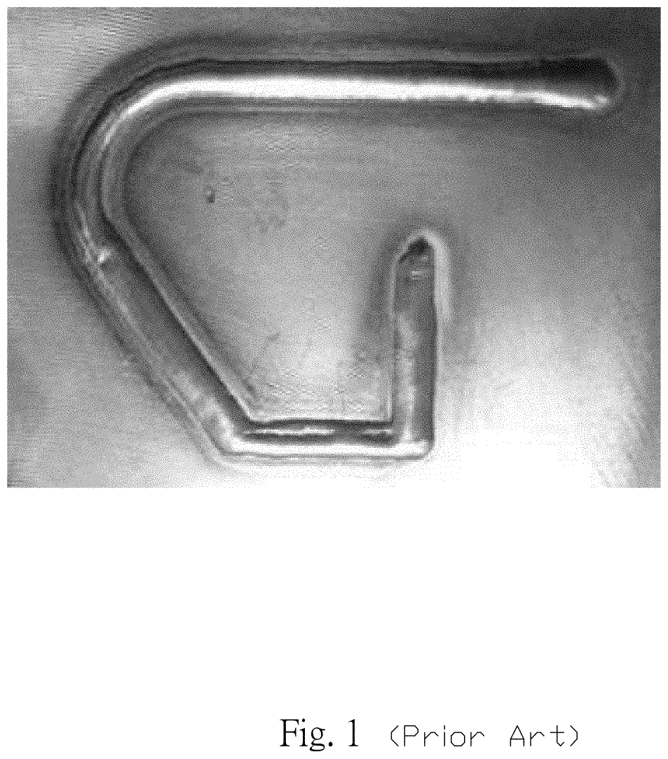

FIG. 2 is a perspective structural view of the present invention.

FIG. 3 is a schematic view showing the operation of the present invention for adjusting the position of the welding head and the discharge port.

FIG. 4 is a schematic view showing the position of the welding head, the discharge port and the weld bead of the present invention.

### DETAILED DESCRIPTION OF THE PREFERRED EMBODIMENTS

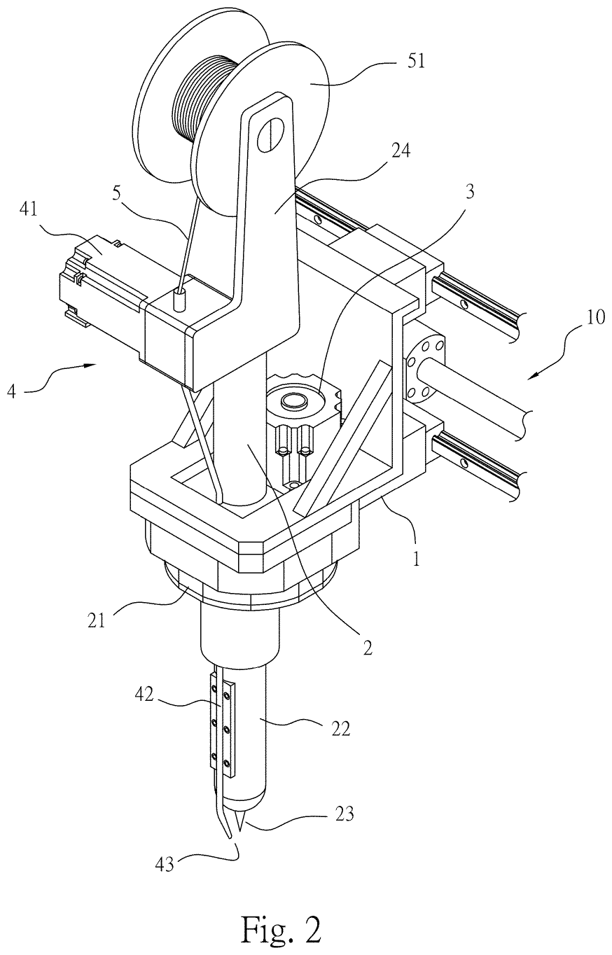

Referring to FIG. 2, the main structure of the present invention includes: a slider 1, a main bracket 2, a pivot drive assembly 3, and a feeding mechanism 4; the sliding block 1 is disposed on a sliding rail mechanism 10, and the sliding rail mechanism 10 can be an end shaft of a working space, suitable for the end shaft of the mechanical arm to drive the sliding block 1 in a working space.

The main bracket 2 is vertically erected on the sliding block 1 via a pivoting seat 21 and extends at one end of the lower bracket 22, and a welding head 23 is disposed at the end of the lower bracket 22, and a pivoting drive assembly 3 is disposed on the sliding block 1 and coupled to the pivoting seat 21, so that the pivoting drive assembly 3 can pivot the main bracket 2 via the pivoting seat 21.

In a preferred embodiment, the pivoting drive assembly 3 can be a step motor or servo motor having a reduction gear set therein, and the main bracket 2 can be driven in the forward and reverse directions via the pivoting seat 21.

The feeding mechanism 4 is disposed at an end of the main bracket 2 away from the welding head 23. The feeding mechanism 4 has a feeding drive assembly 41 and a solder conduit 42 connected to each other, and a solder bracket 24 is disposed on the side of the feeding driving assembly 41. The solder holder 24 is provided with a solder roll 51 for pivoting a strip of solder 5; and the feed driving assembly 41 can receive the solder 5 sent from the solder roll 51 and introduce the solder 5 into the solder conduit 42, The solder conduit 42 extends to the side of the weld head 23 and forms a discharge port 43 for guiding the solder 5, so that the solder 5 derived from the discharge port 43 can be melted at a high temperature generated by the weld head 23 on the preset workpiece.

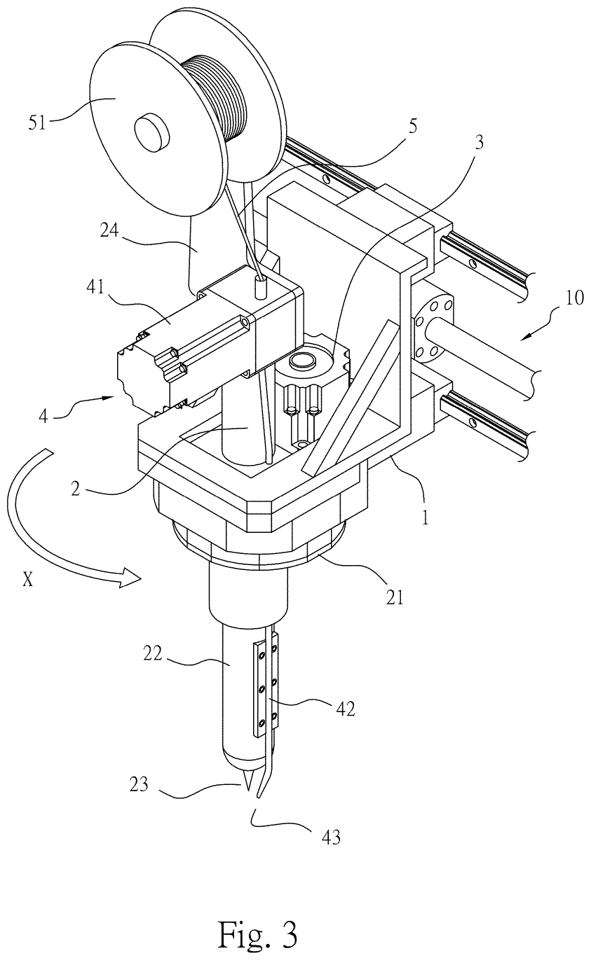

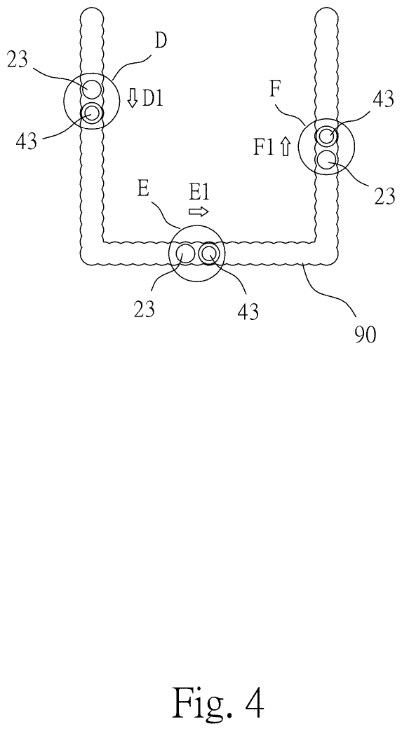

Referring to FIGS. 3 and 4, it can be seen that in the actual application, if a workpiece is to be processed on a U-shaped weld bead 90, and at the initial processing portion D, the discharge port 43 is disposed in front of the welding head 23 along the machining direction D1.

When the slide mechanism 10 drives the sliding block 1 to carry the welding head 23 to enter the processing portion E laterally, the pivot drive assembly 3 can be pivoted in the X direction or the opposite direction via the pivoting seat 21, and the main bracket 2 is pivoted so that the discharge port 43 can be kept in front of the welding head 23 in the machining direction E1.

When the sliding mechanism 10 drives the sliding block 1 to drive the welding head 23 to enter the processing portion F laterally, the pivoting drive assembly 3 can drive the main bracket 2 to pivot again via the pivoting seat 21 so that the discharge port 43 can be held in front of the welding head 23 in the machining direction F1.

In this way, during the processing of the weld bead 90, the discharge port 43 can be kept in front of the weld head 23 with various machining directions, so that the solder 5 is led out from the discharge port 43, and at the same time, the weld head 23 is also moved toward the discharge port 43, so that the solder 5 can smoothly extend beneath the weld head 23 and contact the workpiece thus to be effectively heated by the weld head 23. When the solder 5 is heated and welded onto the workpiece to form the weld bead 90, the weld bead 90 will at the same time smoothly pull the solder 5 in the same direction as drained from the discharge port 43 to obtain significant welding quality and weld bead morphology.

In summary, the welding filler feed-forward maintaining device of the present invention is provided to adjust the relative position of the discharge port and the welding head of the solder according to different machining directions, so that the discharge port is held in front of the welding head along the machining direction to ensure the maintenance of the best welding quality and weld bead morphology.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A welding filler feed-forward maintenance device comprising:
a sliding block disposed on a sliding rail mechanism, wherein a sliding rail mechanism is an end shaft of a working space for driving the sliding block to slide;
a main bracket vertically erected on the sliding block via a pivoting seat, wherein a weld head is extended at one end of the main bracket;
a feeding mechanism having a solder conduit capable of transporting solder, wherein the end of the solder conduit being provided with a discharge port for guiding solder;
a pivoting drive assembly disposed on the sliding block and coupled to the pivoting seat, wherein the pivoting drive assembly is configured to drive the pivoting seat to drive the main bracket to pivot, so that the discharge port is kept in front of the weld head along the welding direction.

2. The welding filler feed-forward maintenance device of claim 1, wherein the feeding mechanism has a feed drive assembly coupled to the solder conduit capable of pushing the solder into the solder conduit and transporting toward the discharge port.

3. The welding filler feed-forward maintenance device of claim 1, wherein the main support is provided with a solder support at one end away from the weld head, and a solder reel that supports the solder roll is pivoted on the solder holder.

4. The welding filler feed-forward maintaining device of claim 2, wherein a solder stand is disposed at one end of the main bracket away from the weld head, and a solder roll that supports the solder roll is pivoted on the solder holder.
